(19) United States
(12) Patent Application Publication
(10) Pub. No.: US 2005/0024412 A1
(43) Pub. Date: Feb. 3, 2005

(54) Liquid usage monitoring

(76) Inventors: Alan L Hudd, Hertfordshire (GB); Philip G Bentley, Cambridge (GB); Andrew D Dubner, St Paul, MN (US); Thomas J Junck, Neuss (DE); Mario Otte, Dusseldorf (DE)

Correspondence Address: 3M INNOVATIVE PROPERTIES COMPANY, PO BOX 33427, ST. PAUL, MN, 55133-3427, US

(21) Appl. No.: 10/477,082

(22) PCT Filed: May 23, 2002
(86) PCT No.: PCT/US02/16548

(30) Foreign Application Priority Data
May 30, 2001 (GB) 0113095.4

(51) Int. Cl. B41J 29/393

(52) U.S. Cl. 347/19

(57) ABSTRACT

A method and apparatus for monitoring usage of liquids of high value or sensitive nature which are applied in repeated small controlled volumes are provided by monitoring and recording parameters including the number of applications, purging, priming and cleaning steps and the usage of liquid supply and circulation pumps. The monitored parameters present a record of the total liquid usage. The recorded usage of the liquid pumps can be cross-checked with the volumes indicated by the other parameters so as to highlight any disagreement between the respective indications of total liquid volumes employed, thereby alerting the user to possible operating problems and permitting prompt remedial action to be taken.

### FIELD OF THE INVENTION

This invention relates to monitoring liquid usage. It is particularly concerned with monitoring to a high level of precision the usage of liquids of high value or potentially sensitive nature.

### BACKGROUND OF THE INVENTION

There is a wide variety of processes and procedures in which the level of usage of a liquid material needs to be monitored. In its simplest form the need is to ensure the presence of sufficient liquid to perform the required duty, for example in a storage vessel such as a vehicle fuel tank. In such applications a float or other liquid level indicator monitors the liquid volume, albeit without great precision, and may trigger a signal to indicate when the volume falls to a low level.

Somewhat more precise monitoring has been provided by flow meters, for example including a rotor or turbine in a liquid conduit, which can be linked directly or indirectly to signalling and control elements. The number of rotations are counted and used to generate a signal indicating the volume flow. Such rotary meters have been well developed in the field of fuel pumps, especially for vehicle filling stations, and provide a sufficiently precise measurement for supply of relatively high liquid volumes. Various features have been adopted for the electrical control circuits of such pumps. For example U.S. Pat. No. 3,990,607 relates to a relay-controlled circuit of a gasoline pump in which momentary closure of a key-operated switch is required before normal operation of the pump can be reinstated after a dispensing operation.

For certain liquids a higher level of monitoring precision is required than for such commodities as gasoline. These liquids include pharmaceuticals, certain chemical treatment agents, radioactive or toxic materials, and special purpose materials, for example special purpose printing inks as may be used in inkjet printers. In general such materials are applied in dosed quantities, i.e. a small controlled volume is applied repeatedly from a source container which is refilled or replaced as the liquid is consumed.

In the field of inkjet printing it is customary to monitor the remaining volumes of ink in supply cartridges so as to warn the user of when to fit a replacement cartridge. In its simplest form the monitoring is provided by a small inspection window in the cartridge. More sophisticated monitoring has been proposed in certain instances. U.S. Pat. No. 6,045,206 discloses a method of operating an inkjet printer comprising the steps of using a maintenance algorithm to control timing of a maintenance action, keeping a historical log of an operating characteristic of the printer over a period of time, and changing the maintenance algorithm for subsequent use by the printer based upon the historical log.

A complete record of the usage of liquid materials requires not just an awareness of operating characteristics and of volumes directly applied, but also any wastage resulting from such steps as priming, purging and cleaning the apparatus used in the application.

### SUMMARY OF THE INVENTION

According to the invention there is provided a method of monitoring the usage of a liquid applied in repeated small controlled volumes from application apparatus which provides for purging, priming and cleaning steps, which apparatus includes one or more liquid pumps for supply or circulation of liquid and in which method parameters of usage are monitored and recorded in transmittable form, the monitored parameters including the number of applications, the number of purging, priming and cleaning steps and the periods of usage of each liquid pump.

The invention further provides apparatus for monitoring the usage of a liquid applied in repeated small controlled volumes, which apparatus provides for purging, priming and cleaning steps and includes one or more liquid pumps for supply or circulation of liquid, in which parameters of usage are monitored and recorded in transmittable form, the monitored parameters including the number of applications, the number of purging, priming and cleaning steps and the periods of usage of each liquid pump.

The objective is to ensure that the monitored parameters represent a substantially complete record of the liquid usage. Given that the typical liquid volume used in each individual application is known, recordal of the number of applications shows the volumes directly used in the application. The volumes used indirectly, and which may be regarded as waste, are shown by the total of any volumes used in purging, priming and cleaning the apparatus. These waste volumes can either be measured directly, for example by measuring an increase in weight of an absorbent material used in cleaning the apparatus, or indirectly by counting the number of purging, priming and cleaning steps and multiplying these by the volumes routinely consumed in these steps.

A particular advantage of the invention is that recordal of the usage of liquid pumps, whose liquid handling capacity can also be determined, provides an indication of total volumes employed, which can be cross-checked with the volumes indicated by the other parameters. Any disagreement between the respective indications of total liquid volumes employed alerts the user to possible operating problems, for example errors or malfunctioning of the apparatus, and permits prompt remedial action to be taken.

In order to increase the level of precision of the usage monitoring, or to provide additional cross-checks on the level of usage, it may also be desirable to monitor other parameters, including for example the number of on and off operations of switches and control valves in the apparatus.

The volumes and/or associated actions of the respective elements are preferably monitored and controlled by one or more microprocessors, for example a programmable logic controller. The microprocessors can be housed within or alongside the application apparatus, but can be located remote from it. In one convenient arrangement one microprocessor forms part of the apparatus as such and another microprocessor is located remotely. A remote location is beneficial in permitting a reduction in on-site inspection time by local personnel and in permitting several application stations to be monitored and controlled from a single point. The microprocessors can be configured to receive data electronically by such transmission routes as a direct wiring connection, dedicated telephone line, radio link or internet link.

### DESCRIPTION OF THE DRAWING

FIG. 1 is a schematic view of liquid usage monitoring system.

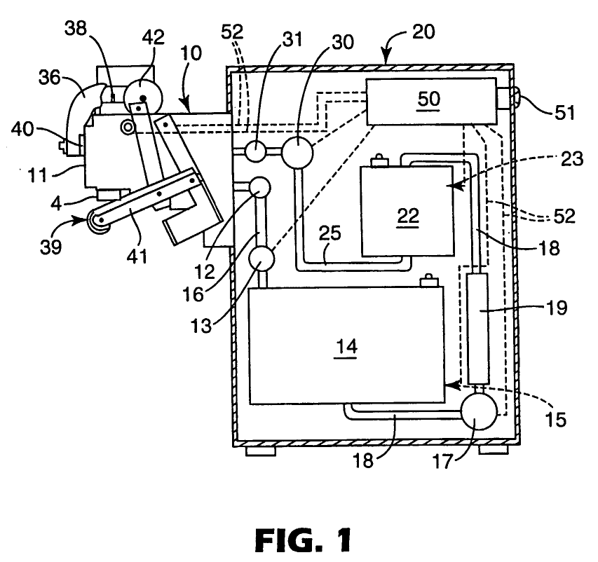

### DESCRIPTION OF THE PREFERRED EMBODIMENTS

In one convenient embodiment of the invention the liquid is supplied from a replaceable container holding a defined initial liquid volume. Because the starting volume in the container and the precise consumption are both known, an operator can determine when the container contents are about to run out and can arrange for a replacement. The precision also allows for substantially complete use to be made of an individual container contents, thereby maximizing the period between container replacements and removing the possibility of significant volumes being returned with the spent container.

The invention is applicable to all types of process liquids that demand special attention. They may be used alone or in some instances may contain constituents in solution or in suspension. Indeed it may be the dissolved or suspended content that gives the liquid the unusual characteristics that demand its carefully monitored usage. For example, the liquids or their constituents may be expensive and therefore used sparingly for reasons of economy. It is therefore desirable to use only as much of such materials as is strictly necessary for a given duty and to dispose effectively of any material not directly employed in the process.

In the case of sensitive materials, especially if they are of a perishable nature, replacement may be necessary before all the container contents have been used. This can be achieved by recording a “use-by” date for the container and checking before a given application that the liquid is prior to that date. The check can be provided by programming a microprocessor to alert the operator to the approach of the expiration date. The microprocessor can also be programmed to stop supply of the liquid at the expiration date. The invention has the further benefit of permitting such checks and control of materials that may have potentially harmful characteristics.

It may be desirable to return the spent container for refilling by an approved supplier. This ensures that the replacement liquid is of an approved quality and in the precise filled volume desirable for successful monitoring. The container is preferably sealed after approved refilling so that tampering with the contents is prevented. Sealing is especially appropriate for handling sensitive or hazardous material in that it protects the user from coming into contact with the material.

In another embodiment of the invention the liquid container may form an integral part of the apparatus employing the liquid. In this embodiment, both the container and the portion of the apparatus of which it forms a part must be returned to the approved supplier for replenishment of the liquid. The returnable unit may desirably be sealed to protect the user from coming into contact with the liquid contents.

For some printing duties, especially those using sensitive inks, the key parameters to be monitored are the number of images applied and a record of the movements of the system, notably when it was returned to a supplier for refilling. These provide the operator with useful data on the number of articles produced and marked and the frequency with which the system must be returned for refilling.

Optionally the monitoring of the transmitted records is effected automatically. The microprocessor can be configured to transmit warning signals, for example when a container is about to run out of liquid.

Individual containers can be marked with one or more serial numbers or codes. This is helpful in identifying the specific container and its contents. In one preferred embodiment of the invention the serial number is recorded on the container in such a way that it can also be transmitted to the microprocessor. This allows the microprocessor to show which container is in place in the application apparatus and further facilitates remote control of when a replacement container will need to be provided. If desired the microprocessor can be programmed so as to permit operation of the apparatus only if it recognizes the container as having an approved serial number, thereby preventing installation in the apparatus of an unapproved container and thus of use of unapproved operating liquid. The recognition may be, for example, by bar-code or radio frequency identification (RFID) tag.

It may additionally be desirable for the microprocessor to demand a password from the operator before opening up the apparatus to the replacement container. This helps to ensure that only appropriately qualified personnel can install the replacements. This option is especially relevant for use of highly sensitive liquids, for example potentially hazardous (such as radioactive) materials.

In the case of particularly sensitive materials it may be desirable to equip the container, and any apparatus of which it forms a part, with a homing device which transmits a signal to indicate its whereabouts. The homing device can be programmed to emit or transmit a warning signal, which again can be an RFID signal, if the container is moved away from known acceptable locations.

The present invention is further described with reference to the accompanying figure which is a schematic side view, partly in section, of the print head of an ink-jet printer fitted with one version of monitoring system according to the invention. The invention is relevant to this application because of the unusual and sensitive nature of certain inks used in the printing process. It is emphasized that the invention is not limited to this application or to the specific version of system described and that not all of the components illustrated in this version represent essential features of the invention.

By way of example it may be noted that the ink used in the inkjet printer may contain a special marker selected from one or more dyes or solid particulate materials. The marker may be of a type that imparts to the deposited image a coloration which is visible in daylight or conventional artificial lighting, or may have no marked colour in daylight or conventional artificial lighting but reveal their colour under special lighting, for example from an ultra-violet or LED source. Alternatively the marker may be a pigment or additive which reveals its presence under the application of magnetic, electronic or spectroscopic means.

Examples of types of pigments used in inkjet printer inks are metallic flakes, inorganic materials comprising ferrites and other metal oxides, including oxides of transition and rare earth metals; organo-metallic complexes; and organic materials, including high molecular weight aromatic compounds such as anthraquinones, aryl amides and quinacridones. Specific examples of commonly used pigments include magnetite, barium ferrite, strontium ferrite, iron oxide, titanium dioxide, copper phthalocyanine and carbon black.

A wide variety of images can be applied by an inkjet printer, including lettering, numerals, figures, photographs, pictures, logos, identifying marks, “sell-by” or “use by” dates as mentioned above, batch numbers, address details and general text. The required degree of precision of the image depends on the duty and the sophistication of the print head.

The system illustrated in the figure is intended for industrial application of coding details, for example batch numbers, to articles on a production line. It includes a print head 10, of a type marketed as a Trident Ultrajet”, attached to the front of a housing 20. The print head 10 has multiple internal capillary channels with ink ejection nozzles 11. Within the print head 10 each capillary has an associated piezoelectric element controlled by energy pulses to eject ink droplets which collectively form the desired image.

A primary reservoir 14 which serves as the main container for ink has an inlet tube 16 and outlet tube 18 and a level sensor 15. The inlet tube 16 includes a flow meter 12, to monitor the rate of ink transfer, and an on-off valve 13.

An ink feed pump 17 in the outlet tube 18 conveys ink through an in-line static mixer 19 to ensure complete dispersion of any ink solids. From the mixer 19 the tube 18 continues to a secondary reservoir 22 located at a higher level than the primary reservoir 14.

The secondary reservoir 22 has an ink level sensor 23, which with the pump 17 maintains the volume of ink in the secondary reservoir 22 at a constant level. An outlet line 25 from the reservoir 22 passes to a priming pump 30 and a flow meter 31.

The print head 10 carries a shaped capping arm 36 rotatably disposed on a shaft 38 and a spring-loaded padded capping plate 40 to close and cap the nozzles 11.

A wiper blade 39 is located at indicated position 39 and extends across the width of the body portion of the print head 10. The wiper blade 39 is mounted on a lever frame 41 comprising interconnected levers moved by an electrically driven wheel 42. One set of levers on the frame 41 is visible at the near side of the print head body portion 10 as viewed in the figure: equivalent levers are located at the far side. An absorbent pad 45 is located beneath the nozzles 11 to receive ink flicked away from the nozzles 11 by the action of the wiper blade 39 and to contact the wiper blade 39 as it returns to the parked position so as to remove any residual ink from it.

At the start of a printing operation the pump 30 is activated to prime the print head 10 with ink. The relative disposition of the reservoirs 14 and 22 is such that because of the height difference ink is siphoned through the print head 10, ensuring that the print head 10 receives a constant flow of ink at a uniform and low ink feed pressure. After the initial priming, the pump 30 can be switched off, ink circulation being then achieved by the siphon effect and the action of the ink feed pump 17 alone.

A programmable logic controller 50 is located inside the housing 20 near the top and is connected by circuit wiring (indicated by dotted lines 52) to the respective elements of the system. The controller 50 has an external port 51 to receive a connector from an associated remote controller (not shown).

Prior to a print run the print head 10 is at rest as shown in the figure, with the capping arm 36 holding the capping plate 40 firmly against the nozzles 11. The capping arm 36 is moved away and the drive wheel 42 is then activated to operate the lever frame 41 so as to move the wiping blade 39 from its parked position to an upper position, slightly above the nozzles 11. The print head 10 is then primed and the nozzles 11 purged by the action of the priming pump 30.

The wiper blade 39 is then brought into operation by continued rotation of the drive wheel 42, causing the frame 41 to draw the wiper blade 39 vertically downwards and over the nozzles 11 to remove any ink from them. Most of any ink on the head face is flicked away by the wiping action of the wiper blade 39 and is deposited on the absorbent pad 45. Residual ink is removed from the wiper blade 39 as it contacts the absorbent pad 45 on its return to the parked position. The volumes of ink removed by the wiper blade 39 are readily taken up by the absorbent pad 45 and are thus effectively removed from the system, being held within the pad 45 such that they cannot result in misuse, for example by an unauthorized party. The pad 45 is replaced by a new pad after a series of print runs.

With the wiper blade 39 and the blade lever frame 41 back in the parked position, the printer is now ready for a print run. At the end of the run the capping arm 36 is returned to the capping position of the figure.

The controller 50 prevents the wiping action from being initiated if the capping plate 40 is in position and, vice versa, prevents the capping arm 36 from being operated if the wiping action is in progress.

The remote controller dictates the image pattern by activating the piezoelectric elements in the print head 10, for example by sending a controlled voltage to the print head 10. Thus effectively it monitors the number of images applied. Together with the controller 50 it can monitor these and all other actions associated with the printing: the initial opening of the on-off valve 13, the capping and uncapping actions of the capping arm 36, purge and priming steps, the wiping action of the wiper blade 39, the number of activations of the liquid pumps and the length of time for which they are operated, the flow rates through meters 12 and 31, and the levels indicated by the level sensors 15 and 23. The controllers can further be programmed to monitor the occasions on which data is extracted from them. The count of the number of marks applied is of particular benefit for a production run of articles which each receive marks such as batch numbers or sell by dates, since the count provides a ready check on the number of articles produced in a given run. Recordal of the monitored data is effected by the controller 50, which can be interrogated by the remote controller or any other chosen control unit.

The level sensor 15 gives a warning of the ink level in the reservoir 14 falling to a point at which the need for refilling is approaching. It also permits any adjustment of any drift in the residual volumes calculated by the controller 50 from its awareness of the direct and indirect usage of the ink. From its awareness of the rate of usage it also permits a precise estimate of when the ink will run out, and thus of the urgency for refilling.

Refilling can either be effected directly by decanting fresh ink into the main reservoir 14 or by removing the reservoir 14 or even the entire unit to a filling station. Removal of the reservoir 14 or unit may be the preferred options for inks of a sensitive or potentially hazardous nature in that the refilling can be conducted by suitably skilled staff under controlled conditions.

1. A method of monitoring the usage of a liquid applied in repeated small controlled volumes from an application apparatus which provides for purging, priming and cleaning steps, which apparatus includes at least one liquid pump (17) for supply or circulation of liquid, said method comprising the steps of:
monitoring one or more parameters of liquid usage;
recording the one or more parameters of liquid usage in a transmittable form;
wherein the one or more parameters of liquid usage include the periods of usage of each liquid pump (17).

2. A method as claimed in claim 1, in which the one or more parameters of liquid usage further include the number of on and off operations of switches and control valves (13) in the apparatus.

3. A method as claimed in claim 1, in which the one or more parameters of liquid usage further include (i) the number of applications, and (ii) the number of purging, priming and cleaning steps.

4. A method as claimed in claim 1, in which the one or more parameters of liquid usage further include the rate of liquid transfer through at least one flow meter (12, 31).

5. A method as claimed in claim 1, further comprising the step of:
cross-checking a total volume of liquid employed, which is determined from the periods of usage of each liquid pump (17) and a liquid handling capacity of each pump (17) with an estimated usage of liquid determined by adding (i) the product of multiplying the number of applications by a typical liquid volume used in each individual application and (ii) the product of multiplying the number of purging, priming and cleaning steps by a volume routinely consumed in these steps.

6. A method as claimed in claim 1, in which the liquid is supplied from a replaceable container holding a defined initial liquid volume.

7. A method as claimed in claim 6, in which the container is returned to an approved supplier for refilling.

8. A method as claimed in claim 7, in which the container is sealed after approved refilling to prevent tampering with its contents.

9. A method as claimed in claim 6, in which the container forms an integral part of the apparatus employing the liquid.

10. A method as claimed in claim 1, in which the volumes and/or associated actions of the respective elements are monitored and controlled by at least one microprocessor.

11. A method as claimed in claim 10, in which a microprocessor is housed within the application apparatus.

12. A method as claimed in claim 11, in which one microprocessor forms part of the apparatus as such and another microprocessor is located remotely.

13. A method as claimed in claim 12, in which the microprocessors are configured to receive data electronically by one or more of a direct wiring connection, dedicated telephone line, radio link or internet link.

14. A method as claimed in claim 10, in which a microprocessor is configured to transmit warning signals.

15. A method as claimed in claim 10, in which a serial number is recorded on one or more liquid containers of the application apparatus in such a way that the serial number(s) can also be transmitted to the microprocessor.

16. A method as claimed in claim 15, in which the microprocessor is programmed so as to permit operation of the apparatus only if it recognizes one or more liquid containers as having an approved serial number.

17. A method as claimed in claim 10, in which the microprocessor is programmed to demand a password before opening up the apparatus to a replacement container.

18. A method as claimed in claim 10, in which the microprocessor is programmed to alert an operator to the approach of an expiration date of the liquid.

19. A method as claimed in claim 10, in which the microprocessor is programmed to stop supply of the liquid at the expiration date of the liquid.

20. A method as claimed in claim 1, in which a homing device associated with one or more liquid containers transmits a signal to indicate its whereabouts.

21. Apparatus for monitoring the usage of a liquid applied in repeated small controlled volumes, said apparatus including:
one or more liquid pumps (17) for supply or circulation of liquid; and
at least one microprocessor (50) to monitor and record in a transmittable form one or more parameters of liquid usage, wherein the one or more parameters of liquid usage include the periods of usage of each liquid pump (17).

22. Apparatus as claimed in claim 21, in which the one or more parameters of liquid usage further include (i) the number of on and off operations of switches and control valves (13) in the apparatus, (ii) the number of applications, (iii) the number of purging, priming and cleaning steps, (iv) the rate of liquid transfer through at least one flow meter (12, 31).

23. Apparatus as claimed in claim 21, wherein the apparatus is capable of cross-checking a total volume of liquid employed, which is determined from the periods of usage of each liquid pump (17) and a liquid handling capacity of each pump (17) with an estimated usage of liquid determined by adding (i) the product of multiplying the number of applications by a typical liquid volume used in each individual application and (ii) the product of multiplying the number of purging, priming and cleaning steps by a volume routinely consumed in these steps.

24. Apparatus as claimed in claim 21, in which one microprocessor forms part of the apparatus and another microprocessor is located remotely.

25. Apparatus as claimed in claim 21, which includes a replaceable container holding a defined initial liquid volume.

26. Apparatus as claimed in claim 21, which includes a homing device which transmits a signal to indicate its whereabouts.

27. An inkjet printer including an apparatus as claimed in claim 21.
